(19) United States
(12) Patent Application Publication
(10) Pub. No.: US 2024/0372058 A1
(43) Pub. Date: Nov. 7, 2024

(54) DIRECT PRINTING OF SOLID-STATE BATTERIES

(71) Applicant: FORD GLOBAL TECHNOLOGIES, LLC, Dearborn, MI (US)

(72) Inventors: Andrew R. DREWS, Ann Arbor, MI (US); Justin PUREWAL, Ann Arbor, MI (US); Matthew DENLINGER, Ferndale, MI (US); Brian Joseph ROBERT, St. Clair Shores, MI (US)

(21) Appl. No.: 18/310,101

(22) Filed: May 1, 2023

(51) Int. Cl. H01M 4/04; H01M 4/70; H01M 10/04; H01M 50/403; H01M 50/46

(52) U.S. Cl. CPC H01M 4/0419; H01M 4/043; H01M 4/70; H01M 10/0404; H01M 10/0468; H01M 10/0486; H01M 50/403; H01M 50/46

(57) ABSTRACT

An electrochemical assembly is comprised of dry electrochemical powder layers (e.g., anode layer, separator layer, cathode layer, and/or current collector layer) that are substantially free of solvent and/or binder. The electrochemical assembly is produced by directly disposing (e.g., printing/spraying) dry powder layers into a non-conductive frame.

### TECHNICAL FIELD

Methods of printing solid-state batteries, and more particularly bipolar solid-state battery assemblies, are provided.

### BACKGROUND

Recently, significant resources and effort have been dedicated towards developing alternative sources of energy. However, many alternative sources require storage of the harnessed energy. Electrochemical cells themselves may be alternative sources of energy or the primary technology for storing harnessed energy.

### SUMMARY

A method of making an electrochemical cell is provided. The method may include disposing a first electrode powder layer of an electrochemical cell in a frame, disposing a second separator layer of the electrochemical cell in the frame, and disposing a third electrode powder layer of the electrochemical cell in the frame such that the separator layer is disposed between the first and second electrode layers.

An electrochemical assembly is provided. The electrochemical assembly includes a frame, a first end plate, a first compact anode powder layer, a first compact separator powder layer, and a first compact cathode powder layer such that the first separator layer is disposed between the first anode and first cathode layers. In a variation, the first endplate is disposed at a first end of the frame and the second endplate is disposed at the second end of the frame such that the endplates sandwich the electrochemical layers. In various embodiments, the frame supports the endplates and various electrochemical layers.

A system to prepare a battery assembly is also provided. The system includes a conveyor assembly, one or more powder deposition devices such as nozzles, and a press. In a variation, the conveyor assembly is configured to receive a frame such as to enclose an electrochemical assembly. In a refinement, the deposition devices (e.g., nozzles) dispense a plurality of electrochemical powder layers within the frame. The press compacts one or more of the electrochemical powder layers.

### BRIEF DESCRIPTION OF THE DRAWINGS

FIG. 1 is a cross-sectional schematic of a system/method of making an electrochemical assembly.

FIG. 2 is a flow chart of the method of making an electrochemical cell assembly.

FIG. 3 is a cross-sectional schematic view of a method of making an electrochemical assembly using a plurality of textured presses.

FIG. 4 is a schematic side view of a carousel assembly for making an electrochemical assembly.

FIGS. 5A and 5B are perspective views of frames or portions thereof including dovetail locks to assemble electrochemical assemblies.

FIG. 6 is a schematic top view of an electrochemical assembly.

FIG. 7 is a cross-sectional schematic side view of an embodiment of electrochemical assembly.

### DETAILED DESCRIPTION

As required, detailed embodiments of the present invention are disclosed herein. However, it is to be understood that the disclosed embodiments are merely exemplary of the invention that may be embodied in various and alternative forms. The figures are not necessarily to scale so some features may be exaggerated or minimized to show details of particular components. Therefore, specific structural and functional details disclosed herein are not to be interpreted as limiting, but merely as a representative basis for teaching one skilled in the art to variously employ the present invention.

Moreover, except where otherwise expressly indicated, all numerical quantities in this disclosure are to be understood as modified by the word “about” in describing the broader scope of this disclosure. Practice within the numerical limits stated is generally preferred. Also, unless expressly stated to the contrary: percent, “parts of,” and ratio values are by weight. The term “polymer” includes “oligomer,” “copolymer,” “terpolymer,” and the like. The description of a group or class of materials as suitable or preferred for a given purpose implies the mixtures of any two or more of the members of the group or class are equally suitable or preferred. Molecular weights provided for any polymers refers to number average molecular weight. A description of constituents in chemical terms refers to the constituents at the time of addition to any combination specified in the description and does not necessarily preclude chemical interactions among the constituents of a mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, a measurement of a property is determined by the same technique as previously or later referenced for the same property.

This disclosure is not limited to the specific embodiments and methods described below, as specific components and/or conditions may vary. Furthermore, the terminology used herein is used only for the purpose of describing particular embodiments and is not intended to be limiting in any way.

The term “substantially” or “generally” may be used herein to describe disclosed or claimed embodiments. The term “substantially” or “generally” may modify a value or relative characteristic disclosed or claimed in the present disclosure. In such instances, “substantially” or “generally” may signify that the value or relative characteristic is within manufacturing tolerance or modified within +0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

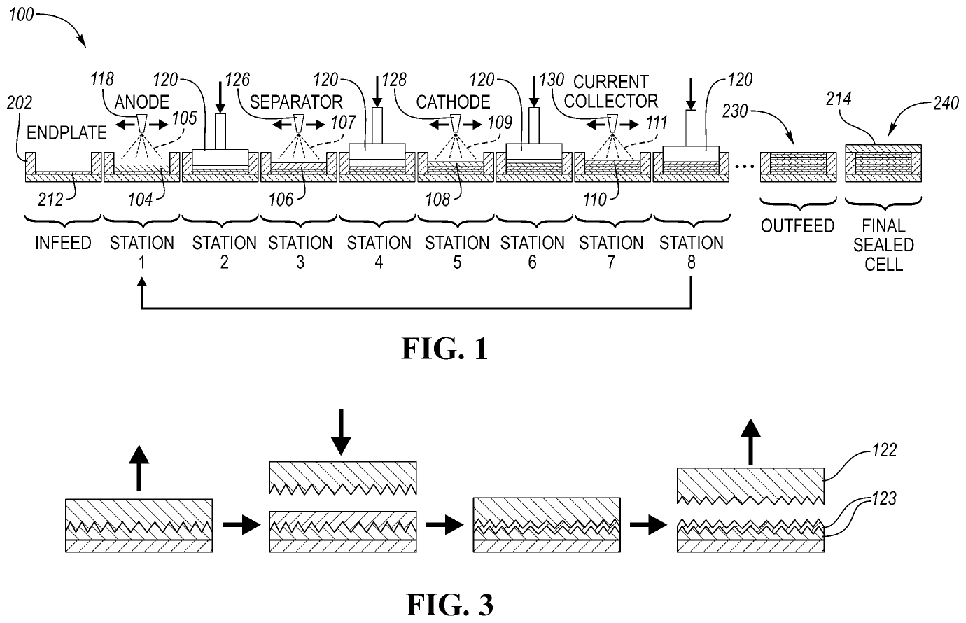

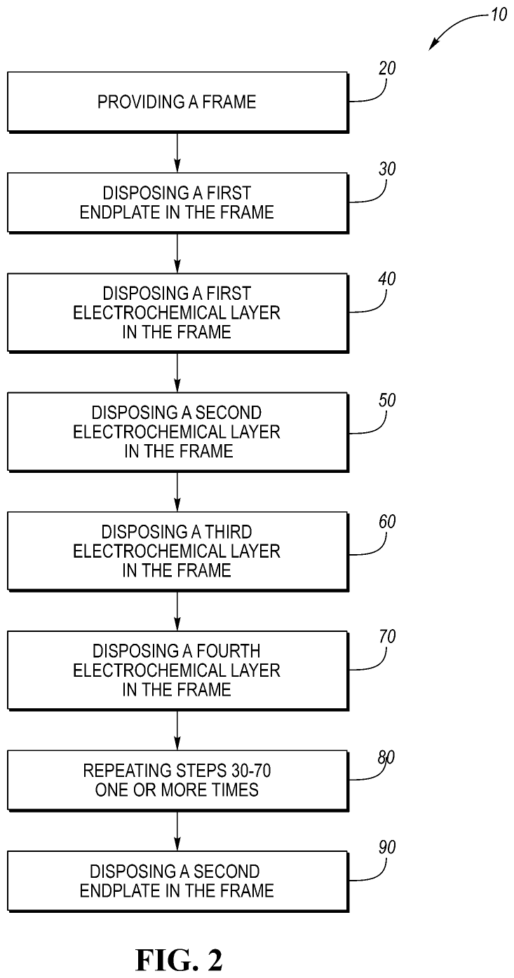

Referring to FIGS. 1-2, a method 10 of making an electrochemical assembly employing a system 100 is provided. The method 10 includes providing a frame 202 (i.e., step 20), disposing a first electrochemical layer 204 in the frame 202 (i.e., step 40), disposing a second electrochemical layer 206 in the frame 202 (i.e., step 50), and disposing a third electrochemical layer 208 in the frame 202 (i.e., step 60). In a refinement, a fourth electrochemical layer 210 may be disposed in the frame 202 (i.e., step 70) adjacent the first and/or third electrochemical layer 204/208.

In various embodiments, the first layer 204, the second layer 206, the third layer 208, and the fourth layer 210 are all different from each other. One or more of the electrochemical layers 204, 206, 208, and 210 are dry (e.g., powder) layers and/or are free/substantially free of solvent. For example, solid and/or powder layers are used. Conventional systems are not directly disposed into an electrochemical frame and thus require inactive binder materials to provide cohesion within each layer or adhesion to (metallic) current collectors. In addition, conventional systems may require excess, non-utilized active areas to accommodate misalignment and provide tolerances. Inactive packaging and sealing materials also further limit the efficiency of conventional electrochemical assemblies. Thus, direct printing, for example, of powders in a frame effectively increases the efficiency and loading of the active material and energy densities. The electrochemical assemblies described herein may be free or substantially free of binder as they are disposed directly in a frame such that cohesion and/or adhesion may be less than conventional assemblies where layers are prepared prior or individually and assembled together but may still move relative to one another. Similarly, the direct disposition of layers into the frame prevents or mitigates misalignment so inefficiencies such as from overhanging electrode layers are eliminated and quality is increased (i.e., direct printing is self-aligning). In a refinement, the various layers may have less than 5% by weight of binder, or more preferably less than 2.5%, or even more preferably less than 1%.

The direct printing of electrochemical layers into an electrochemical frame is a much simpler process than conventional fabrication methods which involve creating liquid solutions and/or slurries and may involve complex drying methods that are energy intensive and require expensive solvent recapture equipment. Conventional systems may also suffer from inefficiencies associated with waste because cells are fabricated from individual electrodes that are cut or punched from coated roll-to-roll foils. Trimmings are discarded and waste material. Here, active materials are only deposited where desired and needed eliminating waste. In other words, there is no or less waste as the assemblies are built to the desired shape and size as defined by the frame.

In one or more embodiments, the second electrochemical layer 206 is disposed on the first electrochemical layer 204 and the third electrochemical layer 208 is disposed on the second electrochemical layer 206 such that the second electrochemical layer 206 is sandwiched between the first and third electrochemical layers 204, 208. The layers may be evenly applied at with any thickness desired to suit the intended use. However, in some applications where energy density is the primary focus, a thick electrode layer may be deposited, for example, at a thickness of up to 100 microns, or more preferably up to 150 microns, or even more preferably up to 200 microns. In other applications where power is the primary focus, a thinner electrode layer may be deposited, for example, at a thickness of less than 100 microns, or more preferably less than less than 75 microns, or even more preferably less than 50 microns. For example, the cathode and/or anode layers may be applied at 10 to 200 microns, or more preferably 25 to 130 microns, or still even more preferably at 50 to 100 microns. In still other embodiments, thicknesses of up to 50 microns may be suitable. The separator layer may be deposited at 1 to 100 microns, or more preferably 5 to 50 microns, or even more preferably 10 to 30 microns. However, it should be understood that the thicknesses of the individual layers and/or stack depends on many variables including the chemistry and/or intended use.

In a refinement, the deposited powders may have an average particle size that is less than the thickness of the deposited layer, or more preferably less than ½ the thickness of the deposited layer, or even more preferably less than ⅓ of the thickness of the deposited layer.

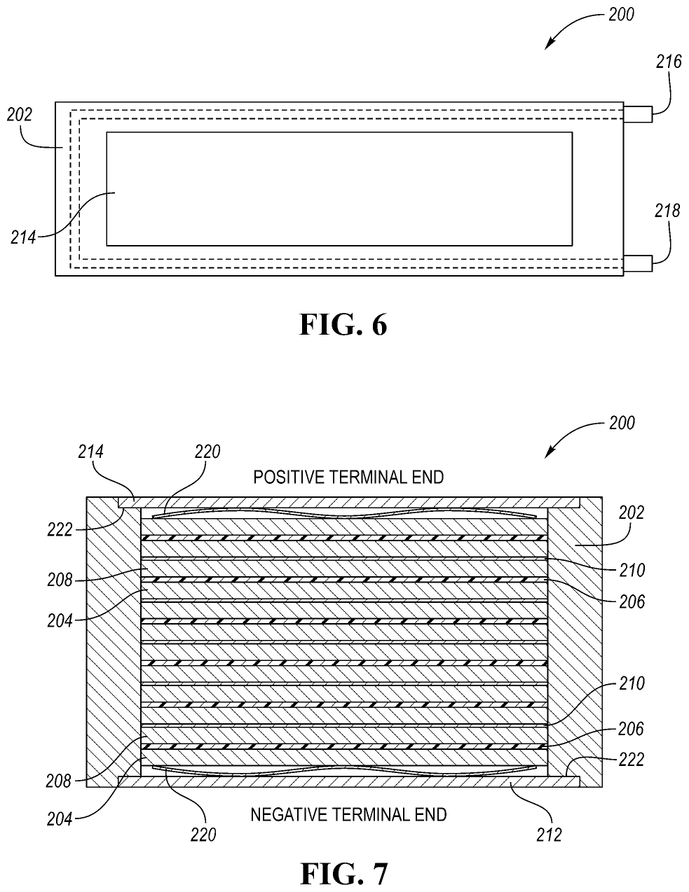

In a variation, steps 40-70 may be repeated one or more times (i.e., step 80), e.g., repeated a plurality of times, to form an electrochemical array/stack, as shown in FIGS. 6-7. For example, deposition in the frame 202 of a first anode layer, a first electrolyte/separator layer, a first cathode layer, a first bipolar plate/current collector, a second anode layer, a second electrolyte/separator layer, a second cathode layer, and a second bipolar plate/current collector layer may be carried out. Additional cell assemblies such as or up to 3, 4, 5, 6, 7, 8, 9, 10, 15, 20, 25, 30, 35, 45, 50, 55, 60, 70, 80, 90, or 100 cells may be included depending on the desired cell voltage. In a variation, the assembly may include, or the process may be repeated at least 5 times, or more preferably at least 10 times, or even more preferably at least 40 times.

In a refinement, a first endplate 212 and a second endplate 214 may be disposed in the frame 202 (i.e., steps 30 and 90 respectively) such that they form the outer most regions of the electrochemical assembly 100 (i.e., the first endplate 212 and the second endplate 214 sandwich the electrochemical layers from the first and second ends of the electrochemical assembly 200). In a variation, the first endplate 212 may be disposed in the frame 202 prior to the electrochemical layers such that the first electrochemical layer 204 (and/or other layers) may be disposed on the first endplate 212. In one or more embodiments, the first and second endplates 212, 214 may form first and second terminals 216, 218 (i.e., a negative endplate terminal and a positive endplate terminal) to provide electrical power to an external circuit. For example, the first end plate 212 may form a negative terminal and the second endplate 214 form a positive terminal. In various embodiments, the electrochemical assembly 200 is hermetically sealed once the various layers are disposed therein. In a refinement, the electrochemical assembly 200 is sealed such that an exterior ambient environment is separate from the interior electrochemical environment to prevent exposure of the active materials such as from oxygen or humidity. For example, a frame may include, support, and/or cooperate with an enclosure to facilitate sealing the electrochemically active materials from the external environment. In a refinement, the method/arrangement has a self-sealing affect as the layers are applied and compacted directly into frame/enclosure, which may be achieved in a controlled environment. The outer edges of the various layers are compacted against the walls of the frame/enclosure such that they form a seal preventing or mitigating exposure to the inner layers once outer layers are applied thereon (i.e., because the layers are disposed directly into the frame/enclosure there are not gaps between the frame/enclosure wall and the layers being disposed therein. Sealing via the frame/enclosure may be easier than conventional sealing mechanism such as with a pouch cell. In still other embodiments, the electrochemical assembly may be constructed such that it includes vents to release gases produced from the electrochemically active component over the life of the assembly, but still preventing or inhibiting the ingress of oxygen and/or humidity. For example, a sealant may be used to seal the assembly within the frame/enclosure.

In one or more embodiments, the solid and/or powder layers may be applied without a solvent (e.g., substantially free of a solvent or entirely free of a solvent) by any suitable powder layer application method known in the art such as powder spraying, powder screeding, powder-bed (3D) printing, electro-spraying and/or (dry) electrostatic deposition. For example, an anode powder layer 104 such as an anode electrode powder 105 may be sprayed by a spray nozzle 118 into the frame 202 and disposed on the first end plate 212, as shown in FIG. 1. In a variation, the newly formed solid and/or powder layer(s) may be compacted such as by one or more presses 120 to create a denser layer, for example, with better adhesive and/or cohesive properties. For example, the first electrochemical layer 204/electrode anode powder layer 104 may be applied by spraying an anode powder 205 in the frame 202. The frame 202 and partial assembly may then be moved beneath the press 120 for compaction. In a refinement, the compacted layer may have a relative density of 50 to 100%, or more preferably 80 to 100%, or even more preferably 95 to 100%, for example, as determined by ISO 1183-1:2004 or ASTM B923.

In a refinement, each layer may be compacted within the frame 202 after it is applied to an adjacent layer. For example, compaction may occur after one or more steps (e.g., each step, a plurality of steps, after all the layers are applied, or after all the steps). Similarly, an electrolyte/separator powder layer 106 may be applied by a spray nozzle 126 which sprays an electrolyte/separator powder 107, and a cathode powder layer 108 may be applied by a spray nozzle 128 which sprays a cathode powder 209. In a refinement, a bipolar substrate/current collector layer 110 may be applied by a powder deposition device 130 which sprays a conductive powder 111, or alternatively, a conductive foil may be inserted. Hereinafter, the term nozzle will be used to describe various embodiments however, it should be understood that various powder deposition devices other than a nozzles may also be used instead of or in combination with a nozzle.

It should be understood that any combination of the following: a single nozzle used to spray multiple different layers; a single press may be used to compact each layer or the assembly; a plurality of nozzles spraying the different layers; and/or a plurality of presses may be used. The assembly may then be sealed, or the process may be repeated a plurality of times to create an unsealed electrochemical array/stack 230 that is later sealed with the second endplate 214 to form a sealed electrochemical array/stack 240. It should further be understood that the application of an individual layer or layers may be applied with one or more passes/powder application layers, nozzle arrangements (e.g., a nozzle, a plurality of nozzles, round nozzles, slit nozzles, nozzle angle, application angle, etc.), and/or flow rates to emphasize and/or mitigate certain electrochemical/mechanical properties depending on the specific chemistries and arrangement to configure it for its intended use.

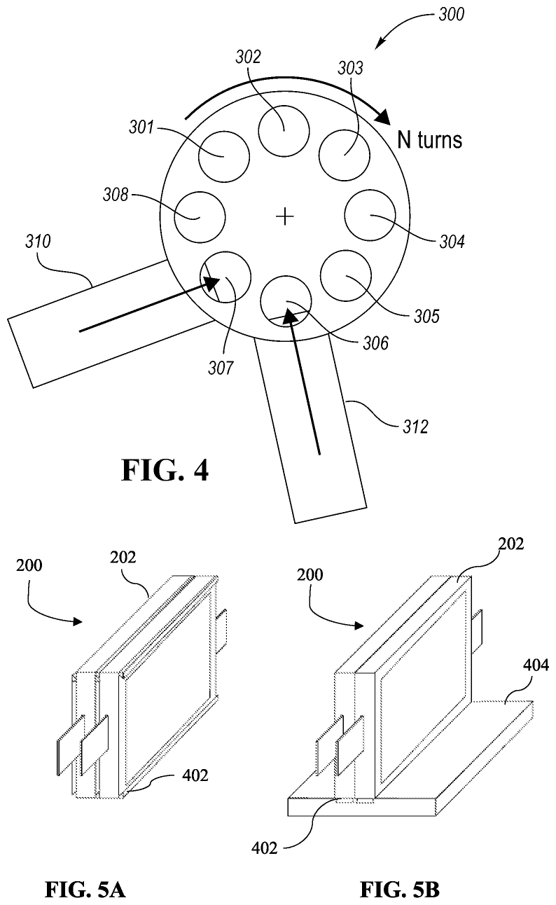

In one or more embodiments, a conveyor and/or carousel/round cassette 300, as shown in FIG. 4, may be used. For example, a single nozzle or press may serve the carousel 300. Alternatively, a plurality of nozzles and/or presses may serve the carousel 300. In a variation, each station 301-308 of the carousel 300 may apply a different layer and/or press. In yet another example, each station 301-308 of the carousel 300 may house its own frame which is simultaneously filled by one or more nozzles and one or more presses. The carousel 300 also includes an infeed 310 and outfeed 312. For example, a nozzle and/or press may be disposed above each station 301-308 of the carousel such that when it rotates a layer is disposed in the frame and/or compacted, i.e., an anode station, a separator station, a cathode station, and/or a current collector station. More or less stations may be included. For example, 3 to 10 stations may be included. In a variation, the carousel 300 may rotate a plurality of times to prepare the array or stack 200. In a refinement, frames each having a first endplate may be received in the carousel 300 via the infeed 310 and an unsealed array/stack may exit the carousel 300 via the outfeed 312 to be sealed with the second endplate. In some embodiments, the frame 202 may be cylindrical.

In various embodiments, the one or more presses 120 may be textured to employ/emboss unique properties/features to one or more layers of the electrochemical assembly 200, as shown in FIG. 3. For example, one or more textured presses 122 may provide one or more textured layers 123 having the following properties such as an increased contact area between the electrode and the separator, and a shorter, less tortuous ionic transport pathway to the electrode active material. In a variation, the press(es) 120 may be heated and/or cooled to facilitate densifying the electrochemical layers. In a refinement, evacuation may be carried out before or after compaction to increase density or clear porosity pathways of one or more layers.

In one or more embodiments, the frame 202 structure may incorporate features that allow the individual cells to be combined to form a rigid structure. In other words, the direct application of the electrochemical components into the frame 202 inherently provides a rigid structure for protection and assembly that would conventionally be added via additional steps to form an array or module.

In various examples, the frames 202 or a portion thereof may include one or more dovetail locks 402 for easier assembly, as shown in FIG. 5A-B. The dovetails 402 may hold the electrochemical cells, arrays, or electrochemical assembly 200 in position. In various embodiments, a portion of the frame may surround a cell or array and be positioned along a plate such as a cold plate 404 via the dovetail locks as shown in FIG. 5B. Each dovetail lock may include protruding portion such as a reversely tapered protrusion that cooperates with a correspondingly shaped recess. In refinement, the endplates 212, 214 may be held or locked into place with a dovetail. In various embodiments, the method described herein may include positioning a plurality of frame portions together by positioning or locking the protruding portions within the recessed portions.

Compaction such as high-pressure compaction may form a monolithic body within the frame 202 that expands and/or contracts together with little friction from the frame 202. In one or more embodiments, the endplates 212, 214 include an adjustment member 220 that allows for expansion and contraction of the electrochemical layers without compromising the hermetic seal 222. In a refinement, one or more end plates 212, 214 may have an elastically deformable portion such as an elastic material or spring disposed between the one or more end plates 212/214, the frame 202, and/or the electrochemical layers. For example, a spring may be disposed between one or more of the endplates 212, 214 and the electrochemical layers as shown in FIG. 7. In a refinement, a rigid plate (not shown) may be disposed between the outer electrochemical powder layer and the spring such that the powder layers are not deformed or disfigured during expansion and contraction and pressure is evenly dispersed along the layer. In another example, an elastic material may be disposed along the edges of the endplate 212/214 connecting the end plate 212/214 to the frame 202. The elastic portion provides flexibility such that it allows for movement of the electrochemical components within the frame 202 without jeopardizing the hermetic seal 222. The adjustment member 220 also should not interfere with the electrical transmission between the stack and the terminals. In a refinement, the adjustment member 220 may be electrically conductive (e.g., a resistivity of no more than 1 Ω·m, or more preferably no more than 10⁻² 1 Ω·m, or even more preferably 10⁻⁷ 1 Ω·m) such that it does not affect the current received by the terminals. In a refinement, the frame 202 may be coated with a non-conductive coating that reduces friction to facilitate expansion and/or contraction without damaging the electrochemical cell(s). In a variation, one or more actuators such as springs may also be disposed between one or more of the endplates 212/214 and the electrochemical layers to accommodate expansion and contraction.

In a variation, the first electrochemical layer 104 may be a first electrode layer, the second electrochemical layer 106 may be an electrolyte/separator layer, the third electrochemical layer 108 may be a second electrode layer, and the fourth electrochemical layer 110 is a bipolar substrate/current collector layer. In a refinement, the first electrode layer is an anode layer or a cathode layer, and the third electrode layer may be the other of the anode layer or the cathode layer. In various embodiments, the electrode layers may be formed from electrode powders. For example, a powder or powder mixture of graphite, lithium titanate (LTO e.g., Li₄Ti₅O₁₂), a tin-cobalt alloy, and/or a silicon-carbon composite may be used for the anode. In a refinement, a powder or powder mixture of lithium iron phosphate (LFP e.g., LiFePO₄) and/or a metal oxide such as a lithium cobalt oxide (LCO e.g., LiCoO₂), a lithium manganese oxide (LMO e.g., LiMn₂O₄ spinel or Li₂MnO₃), a lithium nickel manganese cobalt oxide (NMC e.g., LiNiMnCoO₂), lithium nickel cobalt aluminum oxide (NCA e.g., LiNiCoAlO₂) and/or other lithium and manganese rich (LMR) cathode materials may be used for the cathode.

In one or more embodiments, the electrolyte/separator layer may be a solid-state electrolyte (SSE) such as an inorganic solid electrolyte (ISE), a solid polymer electrolyte (SPE), and/or a composite polymer electrolyte (CPE). In a variation, a polymer or oxide (e.g., a powder such as a poly (ethylene oxide) (PEO), poly (propylene oxide) (PPO), a lithium bis (fluorosulfonyl) imide (LiSI), a polytrimethylene carbonate (PTMC), a poly (acrylonitrile) (PAN), a poly (methyl methacrylate) (PMMA), a poly [bis (methoxy-ethoxy-ethoxy) phosphazene] (MEEP), and/or a poly (vinylidene fluoride) (PVdF))) powder may be used.

In one or more embodiments, the bipolar substrate/current collector layer(s) may be formed from a conductive powder or foil. The bipolar plate/current collector facilitates electron transport but blocks lithium-ion diffusion. In a refinement, the bipolar substrate/current collector is electrochemically stable at both the anode and cathode potentials. For example, a metallic material such as a stainless steel, copper, and/or aluminum or a semi-metallic material may be included. Alloys such as bi-metal alloys e.g., Al—Cu may also be used. In various embodiments, a substrate/current collector foil that may, for example, be coated with a Li metal such as on one side and may be inserted in a single step.

In various embodiments, the frame 202 includes electronically insulating/non-conductive regions such as to prevent or mitigate electrical shorting or is electronically insulating/non-conductive and may incorporate additional useful features directly into the electrochemical assembly 200. In a refinement, the frame 202 includes an insulating material/surface that contacts the electrochemically active components. For example, the contacting surface may be coated to provide electrically insulating properties. In a refinement, the insulating material should prevent dielectric breakdown or is dielectrically equivalent to the electrochemical properties of the assembly (e.g., configured to accommodate the size/voltage of the electrochemical assembly to prevent dielectric breakdown). For example, the frame 202 may be made of or coated with a plastic or ceramic.

In various embodiments the frame 202 incorporates a built-in cooling system such as by providing hollow channels for receiving and circulating fluid (i.e., a cooling loop/jacket), fixtures for fastening the electrochemical assembly 200 into position such as for fastening the assembly 200 to a vehicle, incorporating bussing connections, and/or including built-in monitoring assembly and/or a housing therefor. The method and assemblies described herein may be particularly suitable for bipolar assemblies however, parallel connections may be added to provide other electrochemical assemblies. For example, transfer contacts, parallel connections, and/or bussing connections may be formed at the frame 202 edges.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of making an electrochemical cell comprising:
(a) disposing a first electrode powder layer of an electrochemical cell in a frame;
(b) disposing a separator layer of the electrochemical cell in the frame; and
(c) disposing a second electrode powder layer of the electrochemical cell in the frame such that the separator layer is disposed between the first and second layers.

2. The method of claim 1, wherein the method is substantially free of solvent.

3. The method of claim 1, wherein a foil current collector layer is disposed in the frame adjacent the first and/or second electrode powder layer.

4. The method of claim 1, wherein a current collector powder mixture is disposed in the frame.

5. The method of claim 1, further comprising compacting the layers.

6. The method of claim 5, wherein compacting occurs after each layer is disposed within the frame.

7. The method of claim 5, wherein compacting occurs with a textured press.

8. The method of claim 1, wherein steps (a)-(c) are repeated to form an electrochemical stack including a plurality of electrochemical cells.

9. The method of claim 8, wherein steps (a)-(c) are repeated by rotating the frame on a carousel.

10. The method of claim 1, further comprising disposing a first endplate at a first end of the frame and disposing a second endplate at a second end of the frame such that the first and second endplates sandwich the layers.

11. The method of claim 1, wherein the first electrode layer is anode powder mixture or cathode powder mixture and is disposed on the first endplate, the separator layer is a separator powder and is disposed on the first layer, and the second electrode layer is the other of the anode powder mixture or the cathode powder mixture and is disposed on the separator layer.

12. The method of claim 1, wherein the powder mixtures are powder sprayed.

13. An electrochemical assembly comprising:
a frame supporting a first endplate at a first end and a second end plate at a second end such that the endplates sandwich a first compact anode powder layer, a first compact separator powder layer, and a first compact cathode powder layer, the compact first separator powder layer being disposed between the first anode powder layer and the first cathode powder layer.

14. The electrochemical assembly of claim 13, wherein a second compact anode layer, a second compact separator, and a second compact cathode layer is disposed in the frame.

15. The electrochemical assembly of claim 13, wherein the layers are substantially free of binder.

16. The electrochemical assembly of claim 13, further comprising an adjustment member disposed along the first and/or second endplate to accommodate expansion and contraction of the layers within the frame while maintaining a hermetic seal.

17. The electrochemical assembly of claim 13, wherein the assembly is free of solvent.

18. A system to prepare a battery assembly comprising:
a conveyor assembly to receive a frame of an electrochemical assembly;
one or more nozzles for dispensing a plurality of electrochemical powder layers within the frame; and
a press for compacting the one or more of the electrochemical powder layers.

19. The system of claim 18, wherein the conveyor assembly is a carousel assembly.

20. The system of claim 18, wherein the one or more nozzles includes a first nozzle to dispense an anode powder mixture, a second nozzle to dispense a separator layer, and a third nozzle to dispense a cathode powder mixture.
